(19) United States
(12) Patent Application Publication
(10) Pub. No.: US 2012/0155076 A1
(43) Pub. Date: Jun. 21, 2012

(54) LED-BASED LIGHT EMITTING SYSTEMS AND DEVICES

(75) Inventors: Yi-Qun Li, Danville, CA (US); Gang Wang, Milpitas, CA (US)

(73) Assignee: INTEMATIX CORPORATION, Fremont, CA (US)

(21) Appl. No.: 13/164,535

(22) Filed: Jun. 20, 2011

Related U.S. Application Data
(60) Provisional application No. 61/358,349, filed on Jun. 24, 2010.

(51) Int. Cl. F21V 9/00

(52) U.S. Cl. 362/231

(57) ABSTRACT

A light emitting device comprises: a package; at least one red LED housed in the package and operable to emit red light; at least one blue LED housed in the package and operable to emit blue light wherein the emission product of the device comprises the combination of light emitted by the red and blue LEDs; and a light transmissive material encapsulating the LEDs. Preferably, the package further comprises electrical contacts that are configured such that the drive current of the blue and red LEDs is independently controllable. Devices and/or light emitting systems further comprise a driver operable to control a drive current of the red and/or blue LEDs in response the measured emission intensities of the LEDs such as to maintain a substantially constant ratio of the blue to red light in the emission product.

### PRIORITY CLAIM

This application claims the benefit of priority to U.S. Provisional Patent Application No. 61/358,349, filed Jun. 24, 2010, by Li et al., entitled “LED-BASED LIGHT EMITTING SYSTEMS AND DEVICES”, the specification and drawings of which are incorporated herein by reference.

### BACKGROUND OF THE INVENTION

1. Field of the Invention

This invention relates to LED-based (Light Emitting Diode-based) light emitting systems and LED-based light emitting devices. In particular, although not exclusively, the invention concerns light emitting systems and devices that generate white light.

2. Description of the Related Art

White light emitting LEDs (“white LEDs”) are known in the art and are a relatively recent innovation. It was not until LEDs emitting in the blue/ultraviolet part of the electromagnetic spectrum were developed that it became practical to develop white light sources based on LEDs. As taught, for example in U.S. Pat. No. 5,998,925, white LEDs include one or more phosphor materials, that is photo-luminescent materials, which absorb a portion of the radiation emitted by the LED and re-emit radiation of a different color (wavelength). Typically, the LED chip or die generates blue light and the phosphor(s) absorbs a percentage of the blue light and re-emits yellow light or a combination of green and red light, green and yellow light, green and orange or yellow and red light. The portion of the blue light generated by the LED that is not absorbed by the phosphor combined with the light emitted by the phosphor provides light which appears to the human eye as being white in color.

Due to their long operating life expectancy (>50,000 hours) and high luminous efficacy (70 lumens per watt and higher) high brightness white LEDs are increasingly being used to replace conventional fluorescent, compact fluorescent and incandescent light sources. Today, most lighting fixture designs utilizing white LEDs comprise systems in which a white LED (more typically an array of white LEDs) replaces the conventional light source component. Moreover, due to their compact size, compared with conventional light sources, white LEDs offer the potential to construct novel and compact lighting fixtures.

The ability of a light source to render the color of an object is measured using the Color Rendering Index (CRI) which gives a measure of how a light source makes the color of an object appear to the human eye and how well subtle variations in color shade are revealed. CRI is a relative measurement of the light source's ability to render color compared with a black body radiator. In applications where accurate color rendition is required, such as for example retail lighting, museum lighting and lighting of artwork, a high CRI (typically at least 90) is highly desirable.

A disadvantage of white LEDs can be their relatively low CRI, typically <75, compared with an incandescent source whose CRI >95. The low CRI is due to the absence of light in the red (>600 nm) part of the spectrum. To improve the CRI of a white LED it is known to incorporate a red light emitting LED (red LED). U.S. Pat. Nos. 6,513,949 and 6,692,136 teach hybrid white LED lighting systems comprising a combination of one or more discrete LEDs (red or green) and a discrete phosphor-LED consisting of a blue LED die and a phosphor (green or amber) that is in direct contact with the light emitting face of the blue LED die.

U.S. Pat. No. 6,577,073, to Shimuizu et al., disclose an LED lamp that includes blue and red LEDs and a phosphor. The blue LED produces an emission falling within a blue wavelength range. The red LED produces an emission falling within a red wavelength range. The phosphor is photo-excited by the emission of the blue LED to exhibit photoluminescence having an emission spectrum in an intermediate wavelength range between the blue and red wavelength ranges. The phosphor is in direct contact with the light emitting face of the blue LED die.

Japanese Patent Publication No. JP2008-085026, to Sakai Toyohiro et al., teach a light emitting device comprising a package containing a blue LED with a phosphor on a light emission surface and a red LED in which the blue and red LEDs can be driven independently.

U.S. Pat. No. 7,213,940, to Van De Ven et al., disclose a white light emitting device that comprises first and second groups of solid state light emitters (LEDs) which emit light having a dominant wavelength in a range 430 nm to 480 nm (blue) and 600 nm to 630 nm (red) and a phosphor material which emits light with a dominant wavelength in a range 555 nm to 585 nm (yellow).

Although use of a red emitting LED can improve both luminous efficacy and CRI the inventor has appreciated that such a device has limitations. Most notably the CCT (Correlated Color Temperature) and CRI of light generated by such a device can vary significantly with operating temperature and time. As is known the CCT of a white light source is determined by comparing its hue with a theoretical, heated black body radiator. CCT is specified in Kelvin (K) and corresponds to the temperature of the black body radiator which radiates the same hue of white light as the light source. As represented in FIG. 1a the change in emission intensity of blue and red light emitting LEDs with operating temperature and time are different. Typically the emission intensity of a red LED decreases significantly quicker than a blue LED with increased operating temperature and time. For example over an operating temperature range of 25° C. to 75° C. the emission intensity of a GaN-based blue LED can decrease by about 5% whilst the emission intensity of a AlGaInP-based red LED can decrease by about 40%. In a white light device based on blue and red LEDs these different emission/temperature characteristics will, as shown in FIG. 1b, result in a change in the spectral composition of the emission product and hence an increase in CCT with increased operating temperature. Moreover as shown in FIG. 1b a reduction in the relative proportion of red light in the emission product with increasing operating temperature and time will result in a decrease in CRI.

Color tunable white light emitting devices are known and typically comprise a combination of red, green and blue light emitting LEDs. The color of light emitted by the device can be controlled by controlling the proportion of red, green and blue light present in the emission product. Whilst such a device offers the potential to generate virtually any color of light, the complexity of driver circuitry required to operate these devices can make them too expensive for many applications.

U.S. Pat. No. 7,703,943, to Li et al, discloses a color tunable light emitting device that comprises a first LED arrangement operable to emit light of a first color and a second LED arrangement operable to emit light of a second color, the combined light output comprising the output of the device. One or both LED arrangements comprises a phosphor material that is provided remote to an associated LED operable to generate excitation energy of a selected wavelength range and to irradiate the phosphor such that it emits light of a different color wherein light emitted by the LED arrangement comprises the combined light from the LED and the light emitted from the phosphor. The device further comprises control means operable to control the color of emitted light by controlling the relative light outputs of the two LED arrangements. The color can be tuned by controlling the relative magnitudes of the drive currents of the LEDs or by controlling a duty cycle of a pulse width modulated (PWM) drive current.

It is an object of the present invention to provide a light emitting device that in part at least overcomes the limitations of the known devices and in particular compensates for changes in the emission product arising from differential ageing of LEDs and/or changes in LED emission characteristics due to operating temperature.

### SUMMARY OF THE INVENTION

Embodiments of the invention concern LED-based systems and devices comprising one or more blue LEDs that are operable to generate blue light and one or more red LEDs that are operable to generate red light. The blue and red LEDs are preferably packaged in a single package and configured such the blue and red LEDs are operable from a respective drive current enabling independent control of the blue and red LEDs. In one arrangement the package comprises electrical contacts that are configured such that the drive current of the blue and red LEDs are independently controllable.

The device or system can further comprise a driver for controlling the intensity of light emitted by the blue and red LEDs in response to the measured contributions of blue and red light in the emission product of the device. The driver is configured to control the LEDs such that the contributions of blue and red light in the emission product remain substantially constant. Such a control system can at least in part reduce changes in the color of the emission product of the device due to differential ageing of the blue and red LEDs and/or due to changes in the emission characteristics of the LEDs due to operating temperature. Preferably the device or system further comprises one or more photodetectors, such as photodiodes, that are configured to measure the magnitude of the blue and/or red light components in the emission product and a feedback arrangement for controlling the drive current of the blue and/or red LEDs such that the relative contributions of blue and red light in the emission product are maintained at the selected value.

Additionally the light emission of the blue and red LEDs can be controlled in response to the operating temperature of the LEDs which can be measured using a temperature sensor such as thermistor incorporated in the device package.

The output of the blue and red LEDs can be controlled by controlling the individual drive current of the LEDs or by controlling a single drive current to control the relative outputs of the LEDs. The drive current can be D.C. or PWM (Pulse Width Modulated) and the duty cycle varied to control the drive current.

To generate white light the system and/or device can further comprise at least one blue light excitable phosphor material that is operable to absorb a proportion of the blue light and emit light of a different color typically green, green/yellow or yellow, such that the combined light output of the device appears white in color. In preferred embodiments the phosphor material is provided as a part of a component that is separate to the device enabling the system to generate different colors and/or correlated color temperature of light using the same device. In this patent specification “separate” means not incorporated in the device and indicates that the component and phosphor material are changeable. In one arrangement the phosphor material is incorporated in a light transmissive window that is located remotely to the device. The phosphor material can be homogeneously distributed throughout the volume of the component or alternatively applied to the face of the light transmissive window as one or more layers. The phosphor material can be incorporated in the device package such as for example being applied to at least the blue LED(s). Alternatively where the blue and red LEDs are packaged together, for example in a single cavity, the phosphor material can be applied to the both LEDs.

According to an aspect of the invention a light emitting device comprises: a package; at least one red LED housed in the package and operable to emit red light; at least one blue LED housed in the package and operable to emit blue light wherein the emission product of the device comprises the combination of light emitted by the red and blue LEDs; and a light transmissive material, such as a silicone or epoxy, in direct contact with and covering the LEDs. Typically the light transmissive material encapsulation is of thickness of at least 0.3 mm, at least 0.5 mm or at least 1 mm. In contrast to known LED-based light emitting devices the light transmissive material does not incorporate any phosphor material.

The package preferably has at least one recess for housing the blue and red LEDs. In one arrangement the package has a single recess that is large enough to house both the blue and red LEDs. Alternatively the package can comprise a respective recess for each of the blue and red LEDs. In preferred embodiments the package comprises a square array of recesses in which each recess houses a respective blue or red LED. The package preferably comprises a ceramic material, such as a low temperature co-fired ceramic (LTCC).

In a preferred arrangement the package further comprises electrical contacts that are configured such that the drive current of the blue and red LEDs is independently controllable. In one arrangement a respective electrical contact is provided for the anode of blue and red LEDs. Alternatively and/or in addition the electrical contacts can comprise a respective electrical contact for the cathode of the blue and red LEDs.

Where it is required to generate white light the device further comprises at least one blue light excitable phosphor material that is operable to absorb at least a portion of the blue light emitted by the blue LED and in response emits light of a different color and the emission product of the device comprises a combination of light generated by the red and blue LEDs and light generated by the at least one phosphor material. The at least one phosphor material can be provided as a layer in contact with the light transmissive material that encapsulates at least the blue LED(s). Alternatively the least one phosphor material is provided remote to the device at a distance that is at least 1 mm, at least 5 mm, at least 10 mm or at least 20 mm to the device. In this patent specification “remote” means “not in direct contact with” or “separated from”. Typically the phosphor material is separated from the device by an air gap though it can be separated by a light transmissive medium other than air. Providing the phosphor material remote to the device, more particularly remote to the LED die, can reduce thermal degradation of the phosphor material and produce a more consistent color of emitted light since the phosphor is typically provided over a much greater area as compared to providing the phosphor directly to the light emitting surface of the LED die.

Typically the device is configured such that the combination of light generated by the at least one blue LED and the at least one phosphor material has C.I.E. chromaticity values lying above the black body radiation curve of the C.I.E. chromaticity diagram. In one arrangement the device is configured such that the combination of light generated by the at least one blue LED and the at least one phosphor material has C.I.E. chromaticity values lying within the area of the C.I.E. chromaticity diagram bounded by straight line connecting points of C.I.E. values (0.08, 0.75), (0.43, 0.47), (0.22, 0.26) and (0.09, 0.23) and more preferably lying within the area of the C.I.E. chromaticity diagram bounded by straight line connecting points of C.I.E. values (0.15, 0.58), (0.42, 0.44), (0.29, 0.32), (0.09, 0.31) and (0.09, 0.45).

For lighting applications the device can be configured such that the emission product appears white in color and preferably has chromaticity values substantially lying on the black body radiation curve of the C.I.E. chromaticity diagram.

In a light emitting system incorporating the device of the invention, the system can further comprise a driver operable to control a drive current of the red and/or blue LEDs in response the measured emission intensities of the LEDs such as to maintain a substantially constant ratio of the blue to red light in the emission product. Conveniently, the driver can be incorporated in a power supply used to operate the system or incorporated in the device package.

In devices or systems of the invention the at least one blue LED is operable to generate blue light having C.I.E. chromaticity values within an area bounded by a straight line connecting points on the C.I.E. chromaticity diagram with C.I.E. values (0.08, 0.13) and (0.16, 0.01) and the boundary of the C.I.E. chromaticity diagram connecting said points whilst the at least one red LED is operable to generate red light having C.I.E. chromaticity values on a straight line connecting the points on the C.I.E. chromaticity diagram with C.I.E. values (0.66, 0.34) and (0.72, 0.28).

According to another aspect of the invention a light emitting device comprises: a package; at least one red LED housed in the package and operable to emit red light having a peak wavelength in a range 610 nm to 670 nm; and at least one blue LED housed in the package and operable to emit blue light having a peak wavelength in a range 440 nm to 480 nm, wherein the emission product of the comprises the combination of light emitted by the red and blue LEDs and wherein the package comprises electrical contacts that are configured such that the drive current of the blue and red LEDs is independently controllable.

To enable independent control of the drive current of the blue and red LEDs, the electrical contacts can comprise a respective electrical contact for the anode of the blue and red LEDs. Alternatively and/or in addition the package can comprise a respective electrical contact for the cathode of the blue and red LEDs. In a further arrangement the device comprises a respective electrical contact for the anode and cathode of the blue and red LEDs.

The device can further comprise at least one blue light excitable phosphor material that is operable to absorb at least a portion of the blue light emitted by the blue LED and in response emits light of a different color, wherein the emission product of the device comprises a combination of light generated by the red and blue LEDs and light generated by the at least one phosphor material. The phosphor material can be provided in contact with at least the blue LED(s) such as for example incorporated in a light transmissive material encapsulating the blue LED(s).

Alternatively in a light emitting system incorporating the device of the invention the system can further comprise at least one blue light excitable phosphor material that is operable to absorb at least a portion of the blue light emitted by the blue LED and in response emits light of a different color, wherein the emission product of the system comprises a combination of light generated by the red and blue LEDs and light generated by the at least one phosphor material and wherein the least one phosphor material is provided remote to the device at a distance of at least 1 mm, preferably at least 5 mm, more preferably at least 10 mm or at least 20 mm.

The device or system is advantageously configured such that the combination of light generated by the at least one blue LED and the at least one phosphor material has C.I.E. chromaticity values lying above the black body radiation curve of the C.I.E. chromaticity diagram. Preferably the chromaticity values lie within the area of the C.I.E. chromaticity diagram bounded by straight line connecting points of C.I.E. values (0.08, 0.75), (0.43, 0.47), (0.22, 0.26) and (0.09, 0.23) and more preferably lying within the area of the C.I.E. chromaticity diagram bounded by straight line connecting points of C.I.E. values (0.15, 0.58), (0.42, 0.44), (0.29, 0.32), (0.09, 0.31) and (0.09, 0.45).

The device or system can be configured such that the emission product appears white in color and is preferably configured such that the emission product has chromaticity values substantially lying on the black body radiation curve of the C.I.E. chromaticity diagram.

The device or system can further comprise a driver operable to control a drive current of the red and/or blue LEDs in response the measured emission intensities and/or temperature of the LEDs such as to maintain a substantially constant ratio of the blue to red light in the emission product.

According to a further embodiment a light emitting device comprises a package; at least one red LED housed in the package and operable to emit red light having a peak wavelength in a range 610 nm to 670 nm; at least one blue LED housed in the package and operable to emit blue light having a peak wavelength in a range 440 nm to 480 nm, and at least one blue light excitable phosphor material that is operable to absorb at least a portion of the blue light emitted by the blue LED and in response emits light of a different color, wherein the emission product of the device comprises a combination of light generated by the red and blue LEDs and light generated by the at least one phosphor material and wherein the package comprises electrical contacts that are configured such that the drive current of the blue and red LEDs is independently controllable. In one arrangement the package comprises a respective electrical contact for the anode of the blue and red LEDs. Alternatively and/or in addition the electrical contacts comprise a respective electrical contact for the cathode of the blue and red LEDs. In a further arrangement the package comprises a respective electrical contact for the anode and cathode of the blue and red LEDs.

The device can further comprise a driver operable to control a drive current of the red and/or blue LEDs in response the measured emission intensities and/or temperature of the LEDs such as to maintain a substantially constant ratio of the blue to red light in the emission product.

In a light emitting system incorporating at least one light emitting device of the invention the at least one phosphor material is provided remote to the device at a distance of at least 1 mm, preferably at least 5 mm, more preferably at least 10 mm or at least 20 mm.

The device or system is preferably configured such that the combination of light generated by the at least one blue LED and the at least one phosphor material has C.I.E. chromaticity values lying above the black body radiation curve of the C.I.E. chromaticity diagram. Preferably the chromaticity values lie within the area of the C.I.E. chromaticity diagram bounded by straight line connecting points of C.I.E. values (0.08, 0.75), (0.43, 0.47), (0.22, 0.26) and (0.09, 0.23) and more preferably lie within the area of the C.I.E. chromaticity diagram bounded by straight line connecting points of C.I.E. values (0.15, 0.58), (0.42, 0.44), (0.29, 0.32), (0.09, 0.31) and (0.09, 0.45). Preferably the device or system is configured such that the emission product appears white in color and is preferably configured such that the emission product has chromaticity values substantially lying on the black body radiation curve of the C.I.E. chromaticity diagram.

The system advantageously further comprises a driver operable to control a drive current of the red and/or blue LEDs in response the measured emission intensities of the LEDs such as to maintain a substantially constant ratio of the blue to red light in the emission product.

According to a yet further aspect of the invention light emitting system comprises: a light emitting device comprising: a package; at least one red LED housed in the package and operable to emit red light having a peak wavelength in a range 610 nm to 670 nm; at least one blue LED housed in the package and operable to emit blue light having a peak wavelength in a range 440 nm to 480 nm; and at least one blue light excitable phosphor material that is operable to absorb at least a portion of the blue light emitted by the blue LED and in response emits light of a different color, wherein the emission product of the device comprises a combination of light generated by the red and blue LEDs and light generated by the at least one phosphor material and wherein the at least one phosphor material is provided remote to the device at a distance to the at least of at least 1 mm, at least 5 mm, at least 10 mm or at least 20 mm.

Preferably the package comprises electrical contacts that are configured such that the drive current of the blue and red LEDs is independently controllable. The package electrical contacts can comprise a respective electrical contact for the anode of the blue and red LEDs. Alternatively and/or in addition the electrical contacts comprise a respective electrical contact for the cathode of the blue and red LEDs.

The system can further comprise a driver operable to control a drive current of the red and/or blue LEDs in response the measured emission intensities of the LEDs such as to maintain a substantially constant ratio of the blue to red light in the emission product.

The system can be configured such that the emission product appears white in color and preferably has chromaticity values substantially lying on the black body radiation curve of the C.I.E. chromaticity diagram.

According yet another aspect of the invention a light emitting system comprises at least one red LED operable to emit red light having a peak wavelength in a range 610 nm to 670 nm; at least one blue LED operable to emit blue light having a peak wavelength in a range 440 nm to 480 nm; at least one blue light excitable phosphor material that is operable to absorb at least a portion of the blue light emitted by the blue LED and in response emits light of a different color, wherein the emission product of the device comprises a combination of light generated by the red and blue LEDs and light generated by the at least one phosphor material; and a driver operable to control a drive current of the red and/or blue LEDs in response the measured emission intensities of the LEDs such as to maintain a substantially constant ratio of the blue to red light in the emission product; wherein the at least one phosphor material is provided at a distance of: at least 1 mm, at least 5 mm, at least 10 mm or at least 20 mm.

The system can further comprise a package housing the blue and red LEDs. The package preferably further comprises a respective electrical contact for the anode of the blue and red LEDs. Alternatively and/or in addition the package comprises a respective electrical contact for the cathode of the blue and red LEDs.

Preferably the system is configured such that the combination of light generated by the at least one blue LED and the at least one phosphor material has C.I.E. chromaticity values lying above the black body radiation curve of the C.I.E. chromaticity diagram. Preferably the system is configured such that the combination of light generated by the at least one blue LED and the at least one phosphor material has C.I.E. chromaticity values lying within the area of the C.I.E. chromaticity diagram bounded by a straight line connecting points of C.I.E. values (0.08, 0.75), (0.43, 0.47), (0.22, 0.26) and (0.09, 0.23) and more preferably lying within the area of the C.I.E. chromaticity diagram bounded by straight line connecting points of C.I.E. values (0.15, 0.58), (0.42, 0.44), (0.29, 0.32), (0.09, 0.31) and (0.09, 0.45).

Preferably the system is configured such that the emission product appears white in color and preferably has chromaticity values substantially lying on the black body radiation curve of the C.I.E. chromaticity diagram.

The system preferably further comprises a driver operable to control a drive current of the red and/or blue LEDs in response the measured emission intensities of the LEDs such as to maintain a substantially constant ratio of the blue to red light in the emission product.

### BRIEF DESCRIPTION OF THE DRAWINGS

In order that the present invention is better understood LED-based light emitting systems and devices in accordance with the invention will now be described, by way of example only, with reference to the accompanying drawings in which:

FIG. 1a is a plot of emitted light intensity versus operating temperature for blue and red LEDs as previously described;

FIG. 1b is a plot of CCT and CRI of emitted light versus operating temperature for a known white light emitting device comprising blue and red LEDs as previously described;

FIG. 2 is a C.I.E. (Commission internationale de l'eclairage) 1931 Chromaticity Diagram illustrating the principle of operation of a white LED;

FIG. 3 are a plan view and a cross sectional view through A-A of an LED-based light emitting device in accordance with an embodiment of the invention;

FIG. 4 is a schematic representation of a light emitting system incorporating the light emitting device in accordance of FIG. 3;

FIG. 5 is an exploded perspective view of an LED-based light emitting system, LED downlight, in accordance with the invention;

FIG. 6 are end and sectional views through B-B of the LED downlight of FIG. 5;

FIGS. 7 to 12 are C.I.E. 1931 Chromaticity Diagrams illustrating operation of light emitting system of FIG. 4;

FIG. 13 are a plan view and a cross sectional view through A-A of a color tunable LED-based light emitting device in accordance with another embodiment of the invention;

FIG. 14 is a schematic representation of a color temperature tunable white light emitting system incorporating the light emitting device of FIG. 14; and

FIGS. 15 and 16 are C.I.E. 1931 Chromaticity Diagrams illustrating operation of the light emitting system of FIG. 14.

### DETAILED DESCRIPTION OF THE INVENTION

Embodiments of the invention are directed to LED-based light emitting systems and devices comprising at least one blue LED that is operable to generate blue light and at least one red LED that is operable to generate red light. The system or device can further comprise a driver (controller) for controlling the intensity of light emitted by the blue and red LEDs in response to the measured contributions of blue and red light in the emission product. The driver is configured to control the LEDs such that the contributions of blue and red light in the emission product remain substantially constant thereby maintaining a selected color of emitted light. The driver can be operable to control the emission intensity of one or both LEDs. To generate white light the system or device further comprises at least one blue light excitable phosphor material that is operable to absorb a proportion of the blue light and emit light of a different color typically green, green/yellow or yellow, such that the combined light output of the device appears white in color. In such a device the CCT of the emission product can be maintained by controlling the emission intensities of the blue and red LEDs. Such control can be used to compensate at least in part for changes in the emission product arising from differential ageing of the blue and red LEDs, changes in the emission characteristics of the LEDs due to temperature changes and/or changes in the emission characteristics of the phosphor material.

Throughout this patent specification like reference numerals are used to denote like parts.

White LED

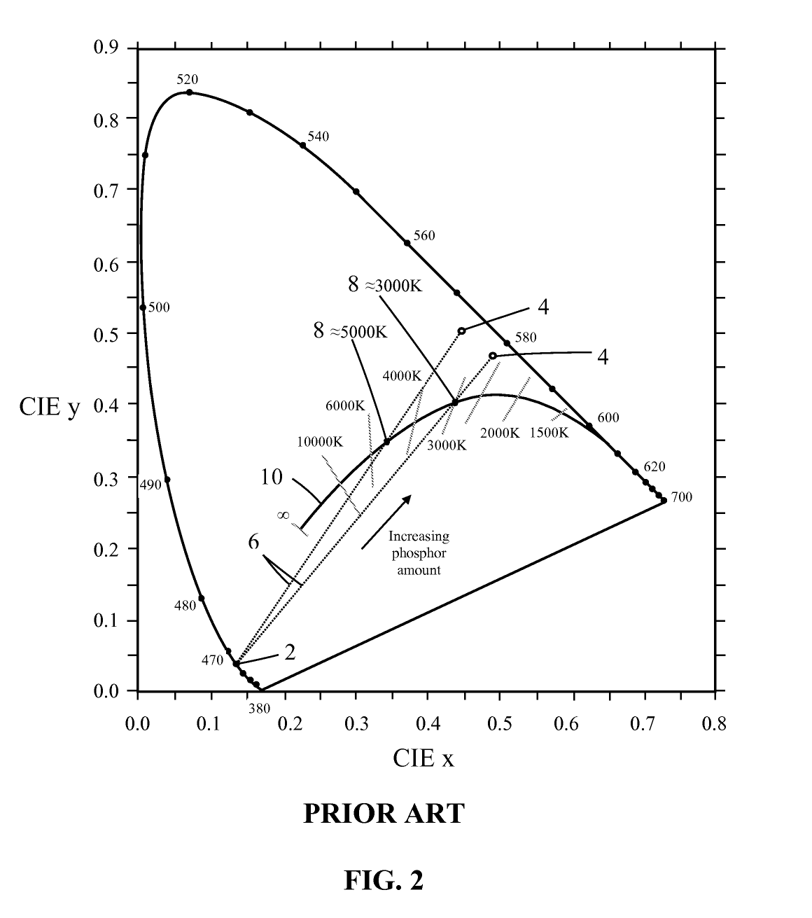

Before describing LED-based light emitting systems and devices in accordance with the invention, the principle of operation of a white LED will be described with reference to FIG. 2 which is a C.I.E. 1931 Chromaticity Diagram.

As is known a white LED typically comprises a blue LED that is operable to generate blue light as indicated by point 2 on the Chromaticity Diagram. In addition a white LED further comprises one or more phosphor materials that are excitable by the blue light and emit light of a different color typically yellow-green in color. In FIG. 2 points 4 indicate the color of light generated by the phosphor material(s) which is dependent on the composition of the phosphor material(s). An approximately straight line 6 connecting the points 2 and 4 represents the possible light emission from the white LED with the exact color of the emission product 8 depending on the quantity of the phosphor material(s). At the point 2, which is the case of no phosphor material, the emitted light is blue in color. At the point 4, which is the case where there is a sufficient quantity of phosphor material(s) to absorb all of the blue light emitted by the LED, the color of emitted light corresponds to the color of light generated by the phosphor material(s). At points along the line 6 intermediate between points 2 and 4 the emitted light is a combination of the light emitted by the phosphor material(s) and the blue light from the LED not absorbed by the phosphor material(s). By appropriate selection of the quantity of the phosphor material(s) the white LED can be configured to generate white light of a selected CCT at point 8 where the line 6 intercepts the black body curve (Planckian locus) 10. The CCT of light generated by a white LED is fixed and is determined by the phosphor material(s) composition and the quantity of phosphor material(s).

A problem with existing white LEDs is that the color of light they generate can change with time as a result of the photoluminescent properties of the phosphor material(s) changing with time for example by the absorption of water (typically the intensity of light emitted by the phosphor material decreases with time). Since the color of light emitted by a white LED is fixed there is no mechanism by which the emission color can be controlled to maintain the emission product at a selected color and/or CCT.

LED-Based Light Emitting Device

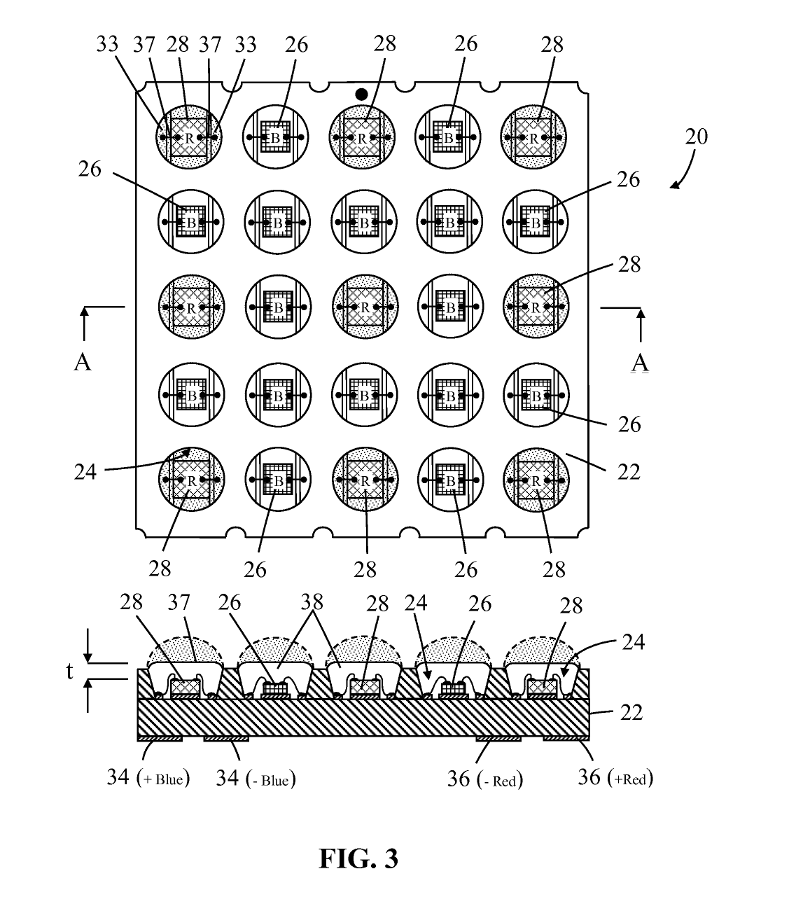

An LED-based light emitting device 20 in accordance with an exemplary embodiment of the invention is now described with reference to FIG. 3 which shows plan and sectional views through A-A of the device. The device 20 comprises a ceramic package 22, such as a low temperature co-fired ceramic (LTCC), having an array of twenty five circular recesses (cavities) 24 configured as a square array 5 rows by 5 columns. Each recess 24 is configured to house a respective one of a blue (B) LED chip 26 or a red (R) LED chip 28. As illustrated the device 20 can comprise sixteen blue LED chips 26 and nine red LED chips 28 in which a respective red LED chip 28 is housed in the center cavity, each of the corner cavities and each of the cavities midpoint along each side. It will be appreciated that the number and configuration of blue and red LED chips is exemplary only and other configurations will be apparent to those skilled in the art.

Preferably the blue LED chips 26 comprise GaN-based (gallium nitride-based) LEDs that are operable is operable to generate blue light 30 having a peak wavelength in a wavelength range 440 nm to 480 nm (typically 465 nm). The red LED chips 28 advantageously comprise AlGaAs (aluminum gallium arsenic), GaAsP (gallium arsenic phosphide), AlGaInP (aluminum gallium indium phosphide) or GaP (gallium phosphide) LED that are operable to generate red light 32 having a peak wavelength in a wavelength range 610 nm to 670 nm.

The wall of each recess 24 can be inclined and can include a light reflective surface such as a metallization layer of silver or aluminum such that each recess 24 comprises a reflector cup for increasing emission of light from the device. The package 22 is a multi-layered structure and incorporates a pattern of electrically conducting tracks configured to interconnect the LED chips 26, 28 in a desired configuration (e.g. serially connected strings of respective LED chips). The conducting tracks are configured such that a part of them extends into the recess 24 to provide a pair of electrode pads 33 on the floor of the recess for electrical connection to a respective LED chip 26, 28. On a lower face of the package 22 solder pads 34, 36 are provided for providing electrical power to the blue and red LED chips. In accordance with an aspect of the invention respective solder pads 34, 36 can be provided for the blue and red LED chips 26, 28 that are configured to enable the forward drive current i_{B}, i_{R} of the blue and red LED chips to be controlled independently. For example, as shown in FIG. 3, the device can comprise four solder pads 34 (+Blue), 34 (−Blue), 36 (+Red), 36 (−Red) respectively corresponding to the anode and cathode of the blue and red LED chips. Alternatively the package can comprise a single solder pad common to one electrode (anode or cathode) of the blue and red LED chips and a respective solder pad for the other electrode of the blue and red LED chips. The solder pads 34, 36 can be connected to the conducting tracks by thermally conducting vias (not shown). Each LED chip 26, 28 is mounted in thermal communication with the floor of the recess using a thermally conducting adhesive such as a silver loaded epoxy or by soldering. Electrodes on the LED chips 26, 28 are connected by a bond wire 37 to a respective electrode pad 33 on the floor of the recess 24. Each recess 24 is completely filled (potted) with a light transmissive (transparent) polymer material 38 such as a silicone or epoxy material and provides protection of the LED chip and bond wires 37. Examples of light transmissive silicone materials can include Shin-Etsu MicroSi, Inc's flexible silicone KJR-9022 and GE's silicone RTV615. The thickness “t” (FIG. 3) of the light transmissive encapsulation 38, measured from the light emitting surface of the LED chip, is typically at least 0.3 mm to 0.5 mm. As shown, the encapsulation 38 can completely fill the recess such that the outer surface of the encapsulation is generally flat. In other embodiments, as indicated by dashed lines in FIG. 3, each recess 24 can be over filled such that the encapsulation is dome-shaped (generally hemispherical) and forms a lens. Such a configuration can increase the total emitted light by reducing the probability of internal reflection within the encapsulation. Typically in such an arrangement the thickness “t” of the encapsulation is at least 1 mm and can be at least 5 mm and largely depends on the size of the recess.

LED-Based Light Emitting System

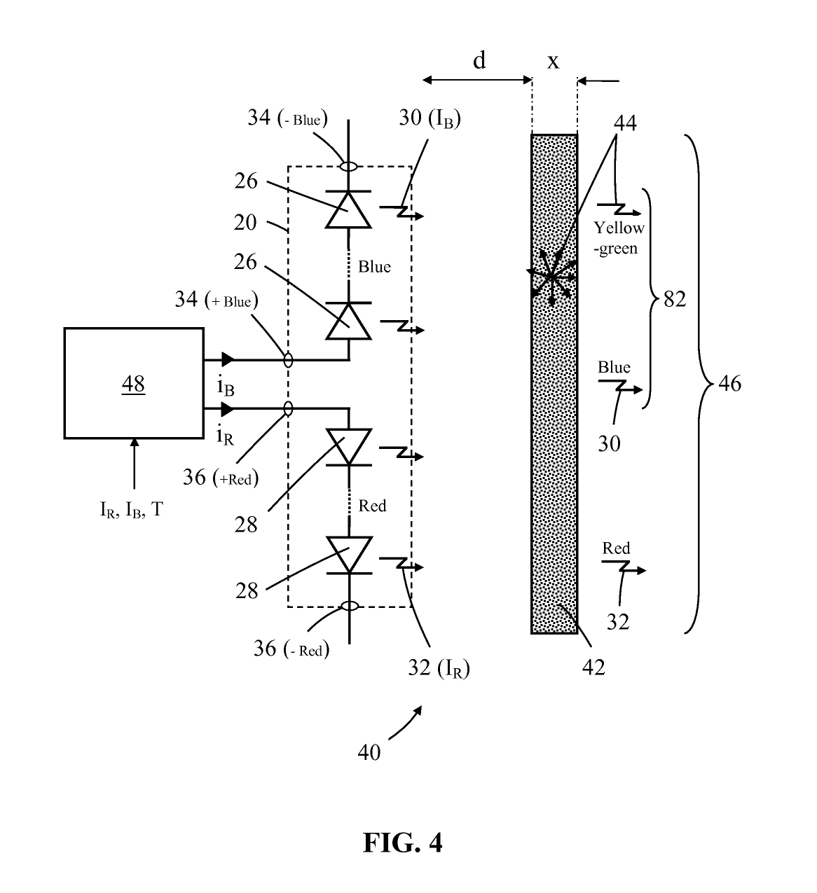

FIG. 4 is a schematic of a white light emitting system 40 incorporating the light emitting device 20 of the invention. As shown in FIG. 4 where it is required to generate white light the light emitting system 40 comprises at least one blue light excitable phosphor material 42 that is configured such that in operation the light emitting device 20 irradiates the phosphor material 42 with blue light 30. The phosphor material 42 absorbs a portion of the blue light 30 and in response emits light 44 of a different color typically yellow-green in color. The emission product 46 of the system 40 comprises the combined light 30, 32 emitted by the LEDs 26, 28 and the light 44 generated by the phosphor material 42.

As will be further described the system 40 can further comprise a driver 48 that is operable to control the forward drive currents i_{FB}, i_{FR} of the blue and red LEDs to compensate for changes in the color of the emission characteristics of the LEDs and/or phosphor material. The driver 48 can be operable in response to the measured intensities I_{B} and I_{R} of the blue and red light contributions in the emission product 46. By means of a feedback arrangement the driver 48 uses the measured intensities I_{B}, I_{R} to adjust the forward drive current i_{B}, i_{R} of the blue and/or red LED to compensate for changes arising in the color of the emission characteristics of the LEDs and/or phosphor material. The driver can alternatively and/or in addition be operable to control one/or both LED drive currents in response to the operating temperature T of the LEDs.

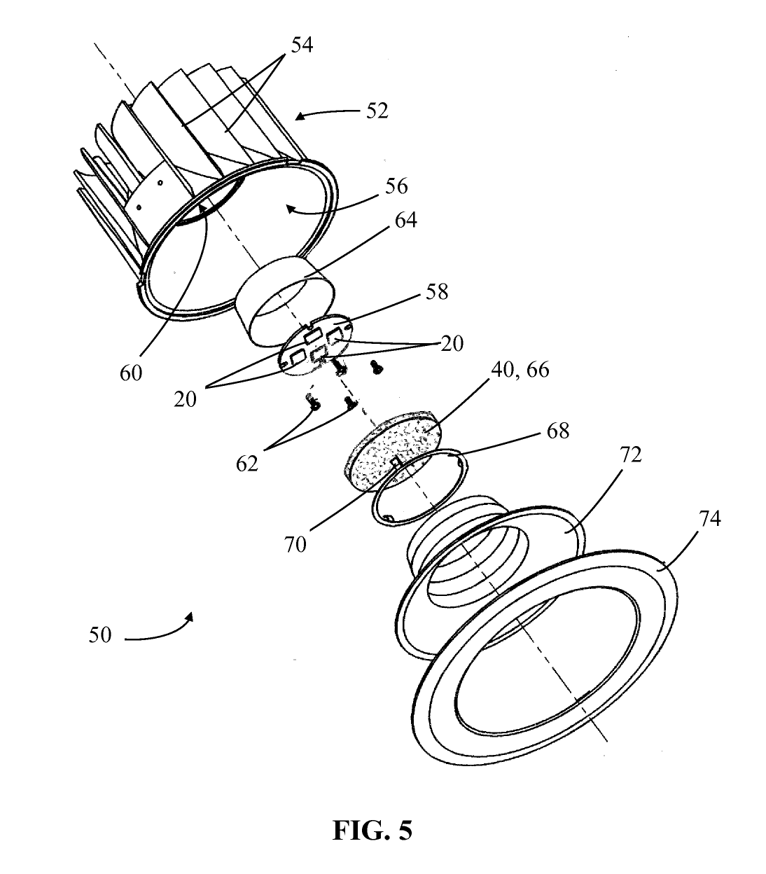

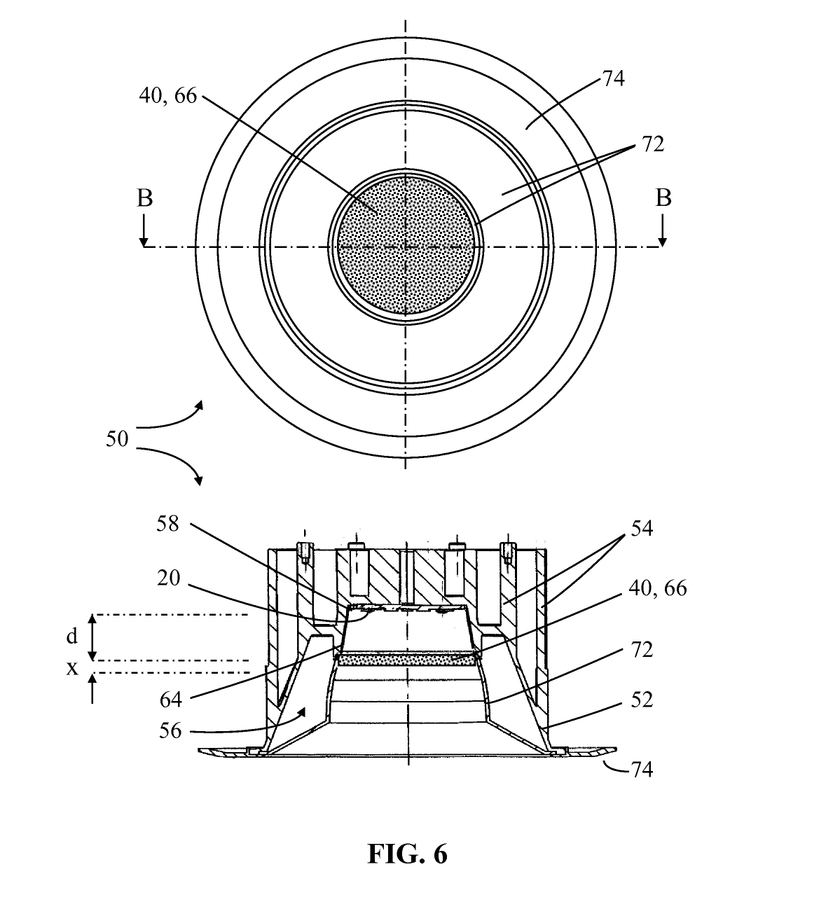

An example of a white light emitting system in accordance with an embodiment of the invention is now be described with reference to FIGS. 5 and 6 in which FIG. 5 is an exploded perspective view of an LED downlight 50 in accordance with the invention and FIG. 6 is an end view of the downlight and a sectional view of the downlight through B-B. The downlight 50 is configured to generate white light with a Correlated Color Temperature (CCT) of ≈3100K, an emission intensity of 650-700 lumens and a nominal beam spread of 60° (wide flood). It is intended to be used as an energy efficient replacement for a conventional incandescent six inch downlight.

The downlight 50 comprises a hollow generally cylindrical thermally conductive body 52 fabricated from, for example, die cast aluminum. The body 52 functions as a heat sink and dissipates heat generated by the LEDs. To increase heat radiation from the downlight 50 and thereby increase cooling of the light emitting device 20, the body 52 can include a series of latitudinal spirally extending heat radiating fins 54 located towards the base of the body. To further increase the radiation of heat, the outer surface of the body can be treated to increase its emissivity such as for example painted black or anodized. The body 52 further comprises a generally frustoconical (i.e. a cone whose apex is truncated by a plane that is parallel to the base) axial chamber 56 that extends from the front of the body a depth of approximately two thirds of the length of the body. The form factor of the body 52 is configured to enable the downlight to retrofitted directly in a standard six inch downlighting fixture (can) as are commonly used in the United States.

Four white light emitting devices 20 in accordance with the invention are mounted as a square array on a circular shaped MCPCB (Metal Core Printed Circuit Board) 58. As is known an MCPCB comprises a layered structure composed of a metal core base, typically aluminum, a thermally conducting/electrically insulating dielectric layer and a copper circuit layer for electrically connecting electrical components in a desired circuit configuration. With the aid of a thermally conducting compound such as for example a standard heat sink compound containing beryllium oxide or aluminum nitride the metal core base of the MCPCB 58 is mounted in thermal communication with the body via the floor 60 of the chamber 56. As shown in FIG. 5 the MCPCB 58 can be mechanically fixed to the body floor 60 by one or more screws, bolts or other mechanical fasteners 62.

The downlight 50 further comprises a hollow generally cylindrical light reflective chamber wall mask 64 that surrounds the array of light emitting devices 20. The chamber wall mask 64 can be made of a plastics material and preferably has a white or other light reflective finish. A light transmissive window 66 is mounted overlying the front of the chamber wall mask 64 using an annular steel clip 68 that has resiliently deformable barbs 70 that engage in corresponding apertures in the body 52.

The light transmissive window 66 includes one or more phosphor materials 40 which can be in the form of one or layers of uniform thickness on one or both faces of the window or homogeneously distributed throughout the volume of the window. In arrangements in which the phosphor material is in the form of one or more uniform thickness layers on the surface of the window, the phosphor material, which is typically in powder form, is thoroughly mixed in pre-selected proportions with a light transmissive (transparent) binder material such as a polymer material such as for example a thermally or UV curable acrylic, silicone or epoxy material, a suitable solvent or a clear ink such as Nazdar 9700 screen ink. Examples of light transmissive silicone materials can include Shin-Etsu MicroSi, Inc's flexible silicone KJR-9022 and GE's silicone RTV615. The weight ratio loading of phosphor to polymer binder is typically in a range 35 to 95 parts per 100 with the exact loading depending on the required CCT of the emission product of the device. The phosphor/polymer is deposited over the face of the window 66 such as to form a substantially uniform thickness layer over the entire surface of the window. Depending on the binder material the phosphor/polymer mixture can be applied to the window by screen printing, spin-coating, doctor blading (i.e. use of a squeegee or flexible bade), tape-casting, spraying, inkjet printing or by other deposition techniques dependent that will be apparent to those skilled in the art. The phosphor/polymer layer 40 is typically of a thickness in a range about 10 μm to about 500 μm, preferably about 10 μm to about 100 μm. As in the case of the weight loading of the phosphor to polymer, the thickness of the phosphor/polymer layer will depend on the target CCT of light generated by the system.

Alternatively as indicated in FIGS. 5 and 6 the phosphor material(s) can be incorporated in the light transmissive window 66. In such arrangements the phosphor material is thoroughly mixed in pre-selected proportions with a light transmissive (transparent) polymer material such as for example a polycarbonate, acrylic, silicone or epoxy and the mixture extruded to form a homogeneous phosphor/polymer sheet of uniform thickness “x” (FIG. 6) with a uniform distribution of phosphor throughout its volume. The weight ratio loading of phosphor to polymer and thickness “x” of the phosphor/polymer sheet will depend on the target CCT of light generated by the system.

It will be appreciated that in this exemplary embodiment the phosphor material is provided remote to the light emitting device 20 (more particularly the blue LED) that is used to excite the phosphor material(s). In this patent specification “remote” means not in direct contact with or separated from typically by for example an air gap. As shown in FIGS. 4 and 6 the phosphor material 40 is separated from the device by an air gap and is located a distance “d” from the light emitting device where d is typically at least 20 mm (2 cm). In other embodiments the phosphor material can be located remote to the blue LED at a distance of at least 1 mm, at least 5 mm or at least 10 mm. This is to be contrasted with the known white light emitting devices (white LEDs) in which the phosphor material is in direct contact with light emitting surface of the LED. Benefits of providing the phosphor remote to the LED die include reduced thermal degradation of the phosphor and a more consistent color and/or CCT of emitted light since the phosphor is typically provided over a much greater area as compared to providing the phosphor directly to the light emitting surface of the LED die. Typically the phosphor material is separated from the blue LED by an air gap though it is envisioned in other embodiments that the phosphor material be separated from the blue LED by other light transmissive mediums. For example the phosphor material can be provided as a layer that is in contact with the light transmissive encapsulation 38.

The phosphor material can comprise an inorganic or organic phosphor such as for example silicate-based phosphor of a general composition A₃Si(O,D)₅ or A₂Si(O,D)₄ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S). The phosphor material, which is typically in powder form, is mixed with a transparent binder material such as a polymer material (for example a thermally or UV curable silicone or an epoxy material) and the polymer/phosphor mixture applied to the light emitting face of the light guide 32 in the form one or more layers of uniform thickness. The color and/or CCT of the emission product of the spotlight is determined by the phosphor material composition and quantity of phosphor material. The phosphor material(s) required to generate a desired color or CCT of white light can comprise any phosphor material(s) in a powder form and can comprise an inorganic or organic phosphor such as for example silicate-based phosphor of a general composition A₃Si(O,D)₅ or A₂Si(O,D)₄ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S). Examples of silicate-based phosphors are disclosed in U.S. Pat. Nos. 7,575,697 “Europium activated silicate-based green phosphor” (assigned to Internatix Corp.), 7,601,276 “Two phase silicate-based yellow phosphor” (assigned to Internatix Corp.), 7,655,156 “Silicate-based orange phosphor” (assigned to Internatix Corp.) and 7,311,858 “Silicate-based yellow-green phosphor” (assigned to Internatix Corp.). The phosphor can also comprise an aluminate-based material such as is taught in U.S. Pat. Nos. 7,541,728 “Aluminate-based green phosphor” (assigned to Internatix Corp.) and 7,390,437 “Aluminate-based blue phosphor” (assigned to Internatix Corp.), an aluminum-silicate phosphor as taught in U.S. Pat. No. 7,648,650 “Aluminum-silicate orange-red phosphor” (assigned to Internatix Corp.) or a nitride-based red phosphor material such as is taught in co-pending U.S. patent application Ser. No. 12/632,550 filed Dec. 7, 2009 (Publication No. US 2010/0308712). It will be appreciated that the phosphor material is not limited to the examples described herein and can comprise any phosphor material including nitride and/or sulfate phosphor materials, oxy-nitrides and oxy-sulfate phosphors or garnet materials (YAG).

The downlight 50 further comprises a light reflective hood 72 which is configured to define the selected emission angle (beam spread) of the downlight (i.e. 50° in this example). The hood 72 comprises a generally cylindrical shell with three contiguous (conjoint) inner light reflective frustoconical surfaces. The hood 72 is preferably made of Acrylonitrile butadiene styrene (ABS) with a metallization layer. Finally the downlight 50 can comprise an annular trim (bezel) 74 that can also be fabricated from ABS.

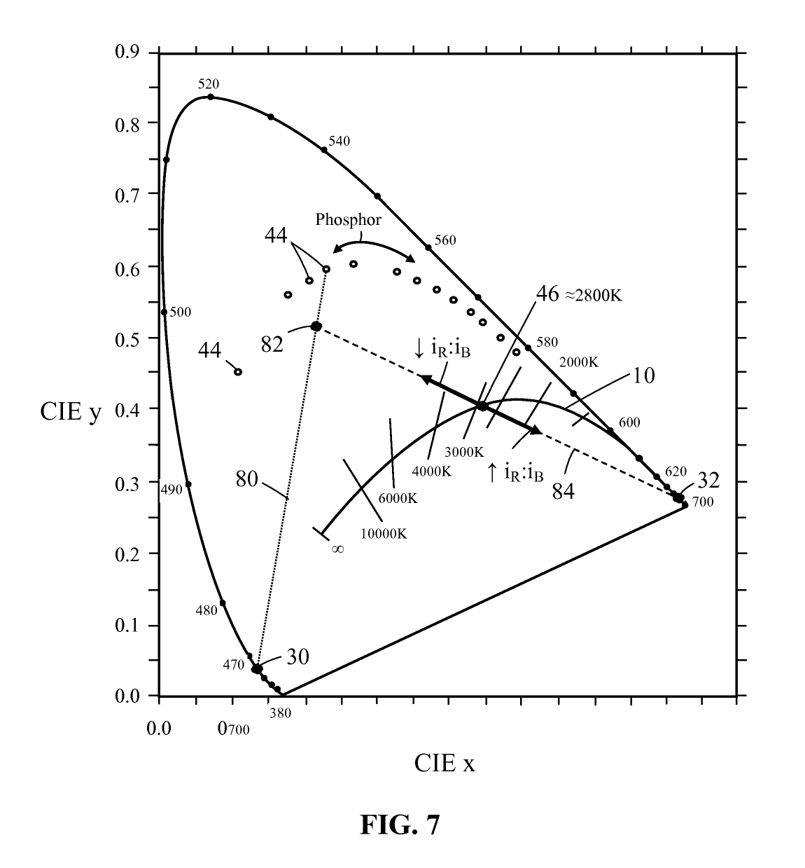

The principle of operation of a white light emitting system 40 and downlight 50 in accordance with the invention is now described with reference to FIG. 7 which is a C.I.E. 1931 Chromaticity Diagram in which points 30, 32, 44 respectively indicate the color of light generated by the blue LED 26, red LED 28 and the phosphor material 42. FIG. 7 also indicates the color of emitted light 44 for a range of phosphor materials such as those produced by Internatix Corporation, Fremont Calif.

An approximately straight line 80 connecting the points 30 and 44 represents the possible light emission for the combined light 82 from the blue LED 26 and the phosphor material 42 with the exact color depending on the quantity of the phosphor material. At the point 30, which is the case for no phosphor material, the combined light 82 is blue in color. At the point 44, which is the case where there is a sufficient quantity of phosphor material to absorb all of the blue light emitted by the blue LED, the color of the combined light 82 corresponds to the color of light generated by the phosphor material. At points 82 along the line 80 intermediate between points 30 and 44 the light is a combination of the light emitted by the phosphor material and blue light not absorbed by the phosphor material. The color of light at point 82 is fixed and is determined by the phosphor material composition and the quantity of phosphor material. It is to be noted that the phosphor material composition and quantity of phosphor material are configured such the combined light 82 emitted by the blue LED 26 and phosphor material 42 lies above the black body radiation curve 10.

The emission product 46 of the system 40 lies on a straight line 84 connecting the points 82 and 32 with the exact point depending on the forward drive currents i_{B}, i_{R} of the blue and red LEDs 26, 28. As shown in FIG. 7 by appropriate selection of the forward drive currents of the LEDs the system can be configured to generate white light of a selected CCT corresponding to the point where the line 84 cuts (crosses, intercepts) the black body radiation curve 10. The CCT of light 46 generated by the system is fixed and is determined by the phosphor material composition and the quantity of phosphor material 42. As illustrated by solid arrows in FIG. 7 by the color of the emission product 46 can be changed by changing the ratio of the forward drive currents i_{R}:i_{B}. Decreasing (↓) the forward drive current i_{R} of the red LED relative to the forward drive current i_{B} of the blue LED (↓i_{R}:i_{B}) causes the color of the emission product 46 to move away from the black body curve 10 along the line 84 towards the point 82. Conversely increasing (↑) the forward drive current i_{R} of the red LED relative to the forward drive current i_{B} of the blue LED (↑i_{R}:i_{B}) causes the color of the emission product 46 to move away from the black body curve 10 in an opposite direction along the line 84 towards the point 32.

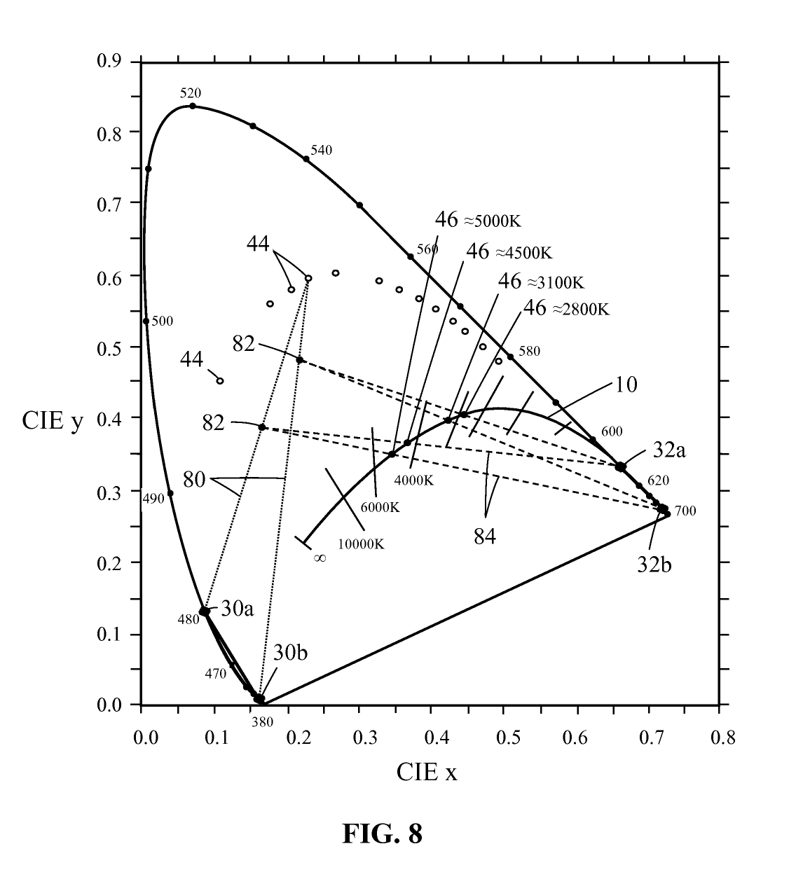

FIG. 8 is a chromaticity diagram indicating chromaticity values of the preferred color of light emitted by the blue 26 and red 28 LEDs. As indicated in FIG. 8 the blue LEDs preferably generates blue light having chromaticity values that are within an area bounded by a straight line connecting points 30a, 30b C.I.E. (0.08, 0.13) and C.I.E. (0.16, 0.01) and the boundary of the chromaticity diagram connecting said points. The red LEDs preferably generates light having chromaticity values lying on a line connecting points 32a, 32b C.I.E. (0.66, 0.34) and C.I.E. (0.72, 0.28).

In common with a white LED the CCT of the emission product 46 of the white light emitting system 40 is fixed and is determined by the phosphor material composition and quantity. However, in contrast to a white LED, by controlling the drive currents of the blue and red LEDs the system of the invention can be configured to reduce the effect on the emission product due to differential changes in light emission of the red and blue LEDs and/or changes in the emission characteristics of the phosphor material due to ageing.

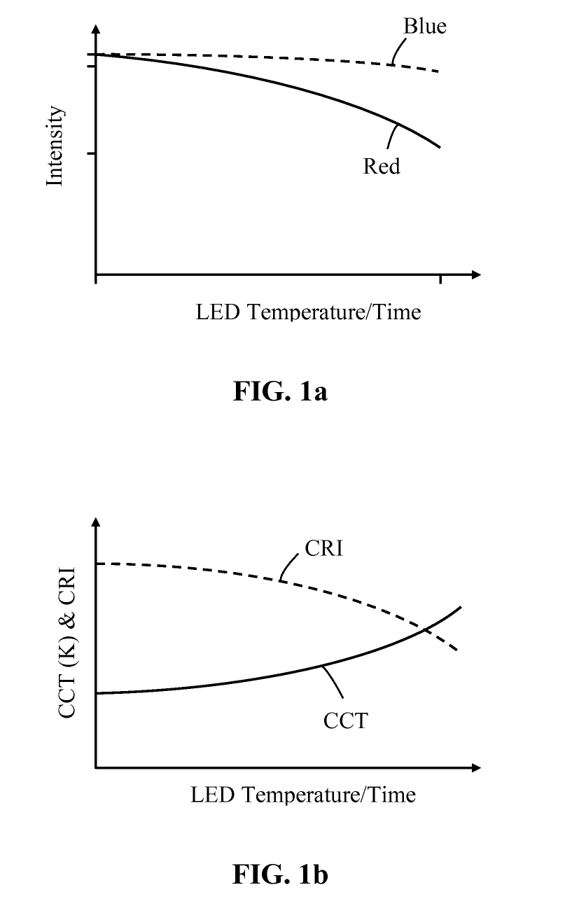

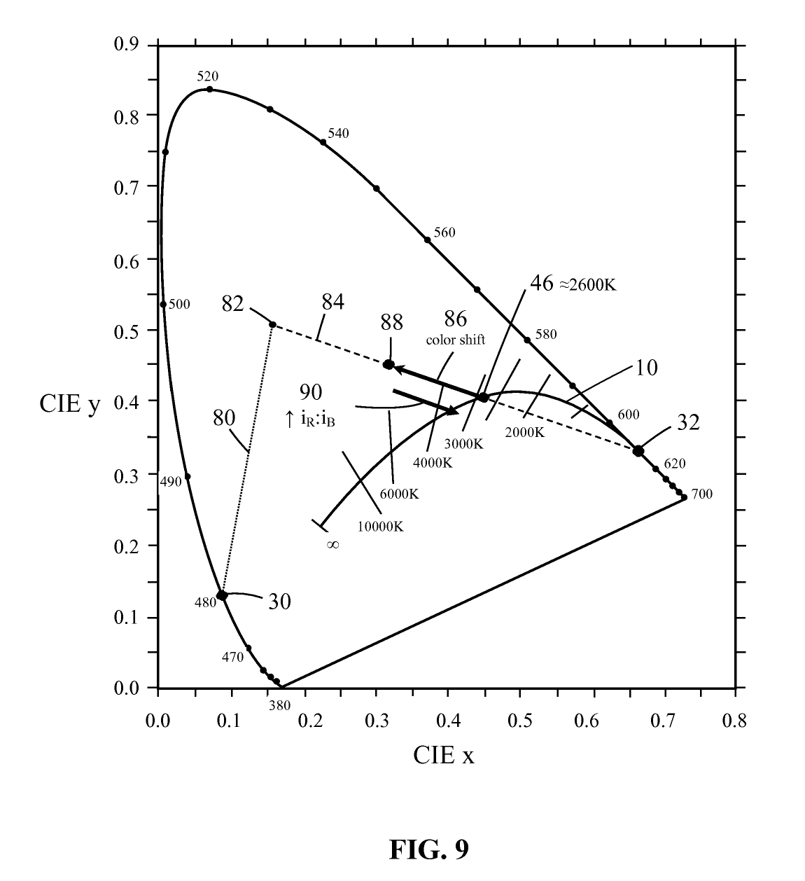

FIG. 9 is a C.I.E. 1931 Chromaticity Diagram indicating how the driver 46 controls the drive currents i_{B}, i_{R} of the blue and red LEDs to compensate for changes in the relative emission characteristics of the red and blue LEDs due to ageing and/or operating temperature. In FIG. 9 the system 40 is configured to generate white light 46 with a CCT of ≈2600K and is based on a blue LED 26 that generates blue light 30 with an emission wavelength λ_{B}=480 nm and a red LED 28 that generates red light 32 with an emission wavelength λ_{R}=610 nm. The phosphor material composition and quantity are selected such that the line 84 connecting points 32 and 82 cuts the black body curve 10 at a CCT≈2600K. As described above the emission intensity of a red LED typically drops more quickly than a blue LED with age and/or operating temperature (FIG. 1a). As shown in FIG. 9 the effect of such a differential change in the emission characteristics of the blue and red LEDs causes a color shift 86 in the emission product 46 of the system away from the black body radiation curve 10 along the line 84 in a direction towards the point 82. Without compensating for such a color shift 86 the system would no longer emit white light and would emit bluish green light as indicated by point 88. In accordance with the invention the effect of the color shift 86 can be reduced, or even eliminated, by changing the relative emissions of the blue and red LEDs 26, 28 by controlling one or both drive currents i_{R}, i_{B}. Increasing the ratio i_{R}:i_{B} 90 (i.e. increasing the light output of the red LED relative to that of the blue LED) the system 40 can be configured to again emit white light 46 with a CCT of ≈2600K.

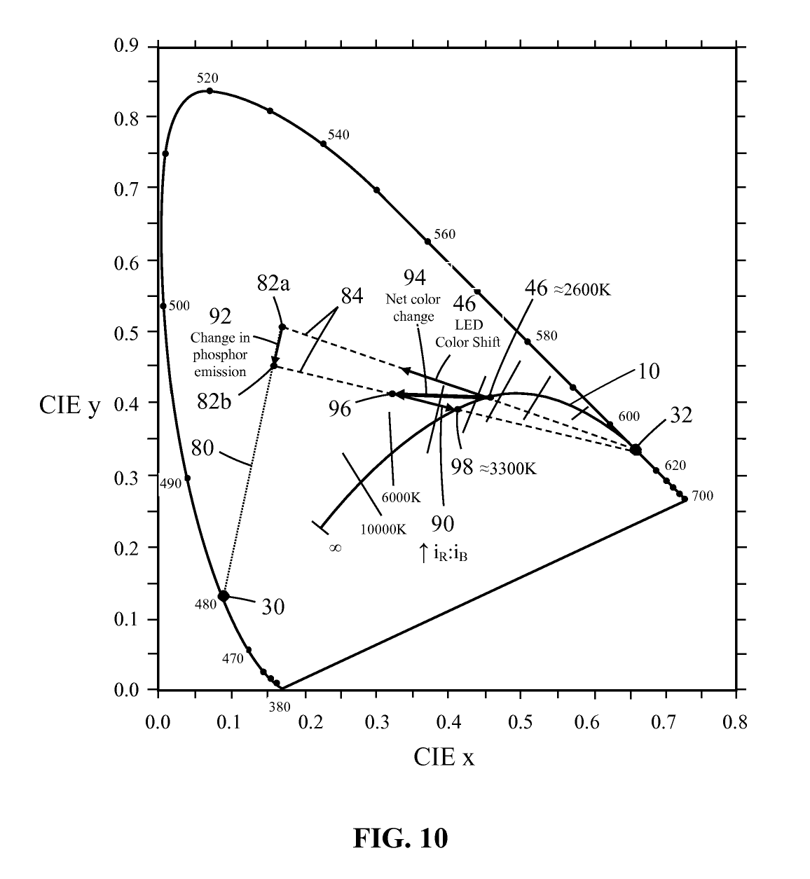

In addition to differential changes in the emission characteristics of the blue and red LEDs the system of the invention can reduce the effect on the emission product of changes in the emission characteristics of the phosphor material, due for example to the uptake of moisture or an increase in operating temperature (typically the intensity of light emitted by the phosphor material reduces with age i.e. a reduction in quantum efficiency). Such a change can be considered to be equivalent to a reduction in phosphor material quantity and as indicated in FIG. 10 results in a change 92 in the combined light 82a emitted by the phosphor material and blue LED along the line 80 in a direction towards the point 30. The new color of the combined light emitted by the phosphor material and blue LED is indicated by point 82b. The net result of changes in phosphor emission and LED emission result in a net color change as indicated by arrow 94 (FIG. 10) and the system no longer emits white light as indicated by point 96. In accordance with the invention the effect of these color changes can be reduced by changing the relative emissions of the blue and red LEDs 26, 28 by controlling one or both of the drive currents i_{R}, i_{B}. Increasing the light output of the red LED relative to that of the blue LED the system can be configured to again emit white light as indicated by point 98 although it will now be of a different CCT where the line 84 connecting points 32 and 82b crosses the back body radiation curve 10. Although the CCT of the white light will not be the same (typically it will be higher due to the reduction in emission intensity of the phosphor material) the human eye is less sensitive changes in CCT than to changes in the actual color of light.

The driver 48 can be configured to adjust the drive currents i_{FB}, i_{FR} of the blue and red LEDs in response to the emission intensity of the blue and red LEDs I_{B}, I_{R}. In one arrangement the emission intensity of the blue and red LEDs is measured using a respective photodetector, such as photodiode or phototransistor, that is incorporated in the light emitting device. Alternatively the intensity of the blue and red light contribution in the emission product 46 can be measured using a respective photodetector that includes a wavelength filter with a spectral response corresponding to the red or blue light. In such an arrangement the photodetectors are preferably a matched pair to reduce any differential temperature effects on the performance of the detectors. Although the device can be controlled in response to the magnitude of the blue and red emission intensities the inventor has discovered that adequate control can be achieved using the ratio of the intensities I_{B}:I_{R} or a difference between the intensities I_{B}−I_{R}. Such a control arrangement reduces the complexity of controller circuitry. A particular benefit of the device of the invention is that since it is based on only red and blue LEDs this reduces the complexity of the driver and eliminates the need to measure the actual color of the emission product of the device.

Additionally the driver 48 can be operable to adjust the drive currents i_{B}, i_{R} of the blue and red LEDs in response to the operating temperature of the blue and red LEDs T. The operating temperature of the LEDs can be measured using a thermistor incorporated in the device. Typically the LEDs will be mounted to a thermally conducting substrate and the temperature of the LEDs can be measured by measuring the temperature of the substrate T which will be approximately the same as the operating temperature of the LEDs.

In operation the driver 48 in response to the measured intensities I_{R}, I_{R} and/or temperature T adjusts the current of the blue and/or red LEDs such as to minimize the change in the ratio I_{B}:I_{R}. The driver 48 can be configured to increase the light output of the red LED by: (i) increasing the forward drive current i_{R} of the red LED while maintaining the forward drive current i_{B} of the blue LED constant or (ii) decreasing the forward drive current i_{B} of the blue LED while maintaining the forward drive current i_{R} of the red LED constant. The first control configuration has the benefit that the intensity of the emission product of the device will not drop as much. It is also envisaged that the driver 48 be operable to adjust both forward drive currents i_{R}, i_{B} such as to minimize any change in the absolute values of the emission intensities I_{R} and I_{B}. Such a control configuration can not only reduce any changes in the color of the emission product but additionally reduces any change in the overall emission intensity of the device.

Whilst the driver has been described as controlling the magnitude of the drive current which implies that the LEDs are driven with a D.C. current it is also envisioned that the drive current be switched dynamically such as a PWM (Pulse Width Modulated) drive current. In such an arrangement the drive can control the magnitude of the drive current by controlling the duty cycle of the current. Preferably the driver 48 is separate to the light emitting device and is conveniently incorporated in an external power supply though it can be incorporated within the light emitting device package.

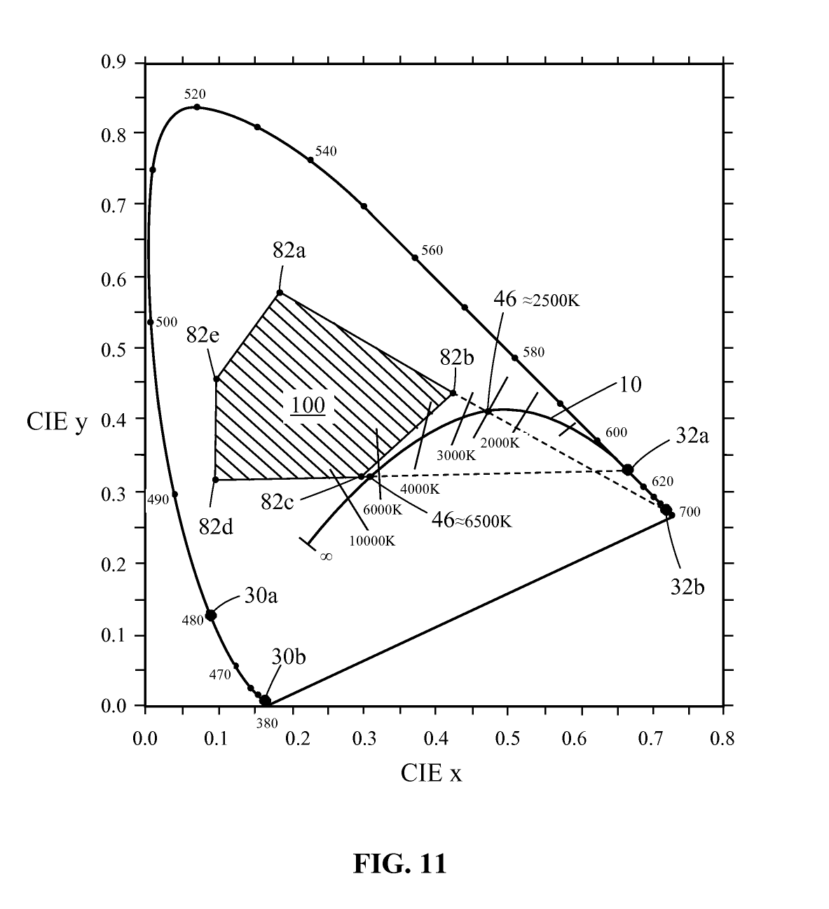

FIG. 11 is a C.I.E. 1931 chromaticity diagram illustrating preferred colors of the combined light 82 emitted by the phosphor material and blue LED for light emitting systems and/or devices configured to generate white light with a CCT in a range ≈2500K to ≈6500K. As indicated in FIG. 11 the color of combined light generated by the blue LED and phosphor material is configured to lie within the area 100 of the C.I.E. diagram bounded by straight lines connecting points 82a to 82e with respective chromaticity values C.I.E. (0.15, 0.58), C.I.E. (0.42, 0.44), C.I.E. (0.29, 0.32), C.I.E. (0.09, 0.31) and C.I.E. (0.09, 0.45). The choice of color is dependent on the selected CCT and on the wavelength of the blue and red LEDs.

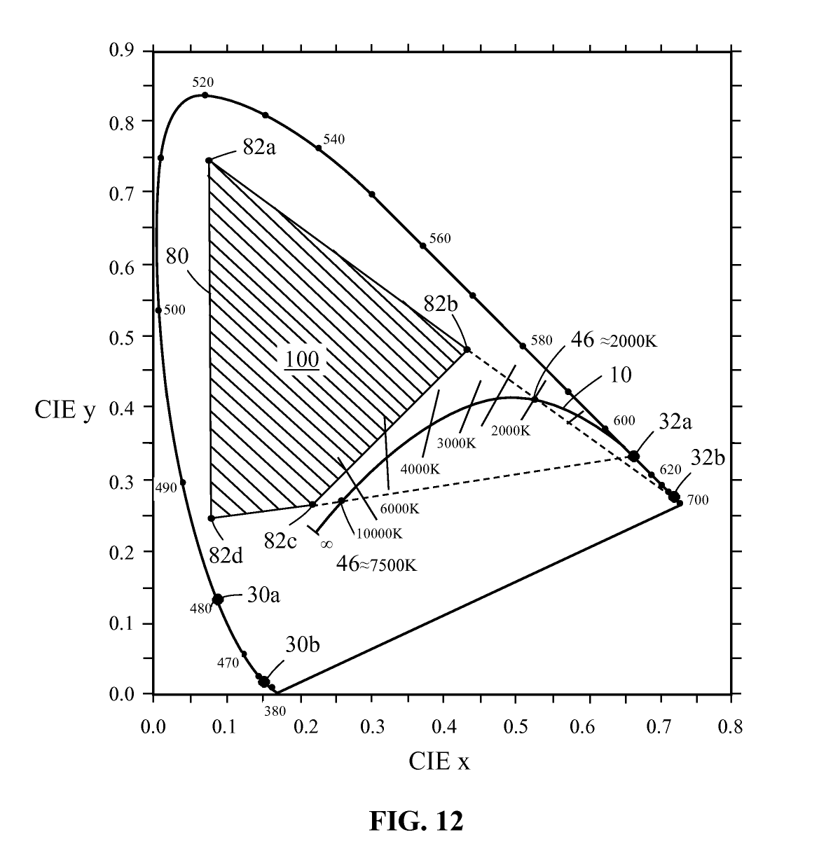

FIG. 12 is a C.I.E. 1931 chromaticity diagram illustrating preferred colors of the combined light 82 emitted by the phosphor material and blue LED for light emitting systems and/or devices configured to generate white light with a CCT in a range ≈2000K to ≈2000K. As indicated in FIG. 12 the color of combined light generated by the blue LED and phosphor material is configured to lie within the area 100 of the C.I.E. diagram bounded by straight lines connecting points 82a to 82d with respective chromaticity values C.I.E. (0.08, 0.75), C.I.E. (0.43, 0.47), C.I.E. (0.22, 0.26) and C.I.E. (0.09, 0.23). The choice of color is dependent on the selected CCT and on the wavelength of the blue and red LEDs.

Color Tunable LED-Based Light Emitting Device

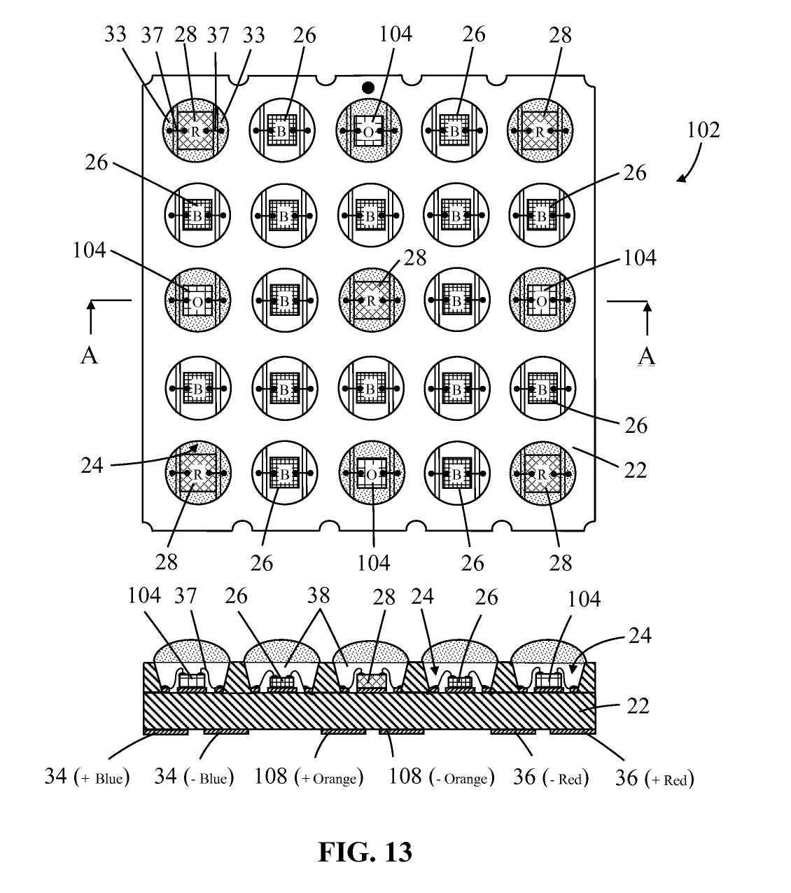

A color tunable LED-based light emitting device 102 in accordance with an embodiment of the invention is now described with reference to FIG. 13 which are plan and sectional views through A-A of the device. The device 102 is similar to the device of FIG. 3 and comprises a ceramic package 22 having an array of twenty five circular recesses (cavities) 24 configured to house a respective one of a blue (B) LED chip 26, a red (R) LED chip 28 or an orange (O) LED chip 104. As illustrated the device 102 can comprise sixteen blue LED chips 26, five red LED chips 28 and four orange LED chips 104 in which a respective red LED chip 28 is housed in the center cavity and each of the corner cavities and a respective orange LED chip 104 is housed in each of the cavities midpoint along each side. It will be appreciated that the number and configuration of blue, red and orange LED chips is exemplary only and other configurations will be apparent to those skilled in the art.

The orange LED chips 104 can comprise GaAsP-based (gallium arsenide phosphide), AlGaInP (aluminum gallium indium phosphide) or GaP-based (gallium phosphide) LEDs that are operable is operable to generate orange light 106 having a peak wavelength in a wavelength range 590 nm to 610 nm. On a lower face of the package 22 solder pads 34, 36, 108 are provided for providing electrical power to the blue, red and orange LED chips. In accordance with the invention respective solder pads 34, 36, 108 are provided for the blue, red and orange LED chips 26, 28, 104 that are configured to enable the drive current i_{FB}, i_{FR}, i_{FO} of the blue, red and orange LED chips to be controlled independently. For example in one arrangement six electrode pads 34 (−Blue), 34 (+Blue), 36 (−Red), 36 (+Red), 108 (−Orange), 108 (+Orange) can be provided corresponding to the cathode and anode of the blue, red and orange LED chips (FIG. 13). Alternatively the package can comprise a solder pad (cathode or anode) that is common to the LED chips and a respective electrode pad for the other electrode of the blue, red and orange LED chips.

Color Temperature Tunable LED-Based Light Emitting System

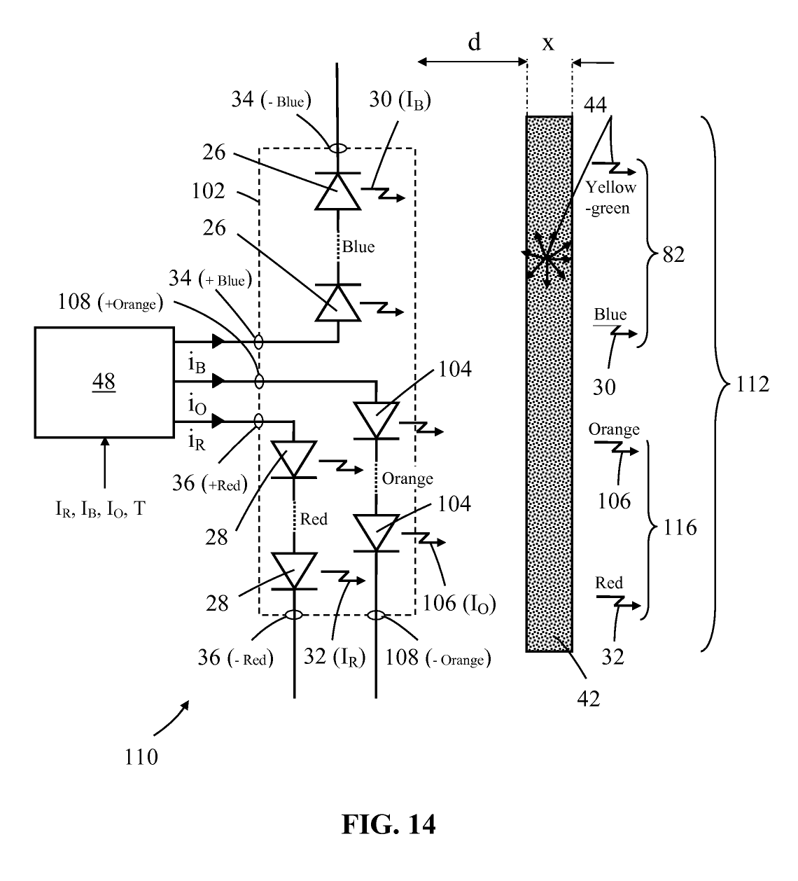

FIG. 14 is a schematic of a color temperature tunable white light emitting system 110 based on the light emitting device 102 of FIG. 13. The light emitting system 110 comprises at least one blue light excitable phosphor material 42 that is configured such that in operation the light emitting device 102 irradiates the phosphor material 42 with blue light 30. The phosphor material 42 absorbs a portion of the blue light 30 and in response emits light 44 of a different color typically yellow-green in color. The emission product 112 of the system 110 comprises the combined light 30, 32, 106 emitted by the LEDs 26, 28, 102 and the light 44 generated by the phosphor material 42.

The system 110 can further comprise a driver 48 that is operable to control the forward drive currents i_{B}, i_{R}, i_{O} of the blue, red and orange LEDs to compensate for changes in the color of the emission characteristics of the LEDs and/or phosphor material. The driver 48 can be operable in response to the measured intensities I_{R}, I_{R}, I_{O} of the blue, red, orange light contributions in the emission product 112. By means of a feedback arrangement the driver 48 uses the measured intensities I_{B}, I_{R}, I_{O} to adjust the forward drive current i_{B}, i_{R}, i_{O} of the blue, red and/or orange LEDs to compensate for changes arising in the color of the emission characteristics of the LEDs and/or phosphor material. The driver can alternatively and/or in addition be operable to control one/or more LED drive currents in response to the operating temperature T of the LEDs.

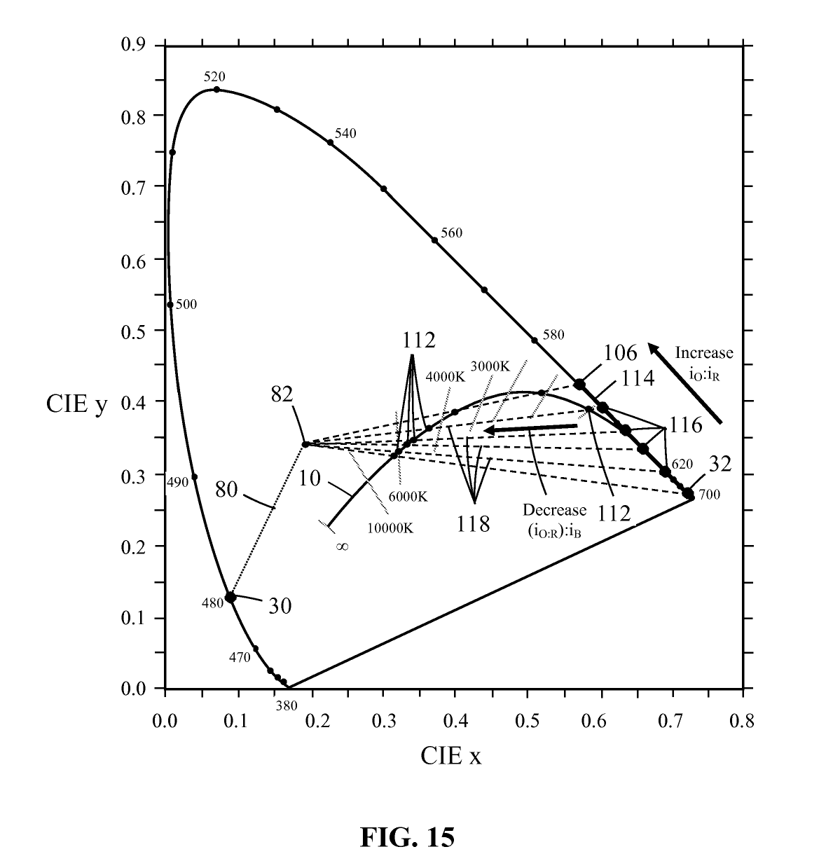

The principle of operation of the white light emitting system 110 is now described with reference to FIG. 15 which is a C.I.E. 1931 Chromaticity Diagram in which points 30, 32, 106 respectively indicate the color of light generated by the blue 26, red 28 and orange 104 LEDs. A heavy solid line 114 connecting the points 30 and 106 represents the possible light emission for the combined light 116 from the red and orange LEDs with the color depending on the ratio i_{O}:i_{R} (i_{O:R}) of the forward drive current of the orange and red LEDs. The emission product 112 of the system 110 lies on a straight line 118 connecting the points 82 and 116 with the exact point depending on the ratio of the forward drive currents of the orange/red to blue LEDs (i_{O:B}):i_{B}. As indicated in FIG. 15 by appropriate selection of the ratio (i_{O:R}):i_{B} the system can be configured to generate white light of a selected CCT corresponding to the point where the line 118 cuts (crosses, intercepts) the black body radiation curve 10. By including the orange LEDs, this enables the CCT of light 112 generated by the system to be tuned and depends on the ratio i_{O:R} of the forward drive current of the orange to red LEDs. In common with the system of FIG. 4 the color of the combined light 82 generated by the blue LEDs and phosphor material is fixed and is determined by the phosphor material composition and the quantity of phosphor material. However the CCT of the emission product 112 of the system is determined by the point at which line 118 intercepts the black body radiation curve which depends on the color of the combined light 116 generated by the red and orange LEDs. Since the drive currents of the red and orange LEDs can be controlled independently this enable line 118 and hence CCT to be selected. For example the greater the ratio i_{O:R} the lower the CCT of the emission product. As indicated in FIG. 15 for certain colors of light 116 the line 118 can intercept the black body radiation curve at two different CCT.

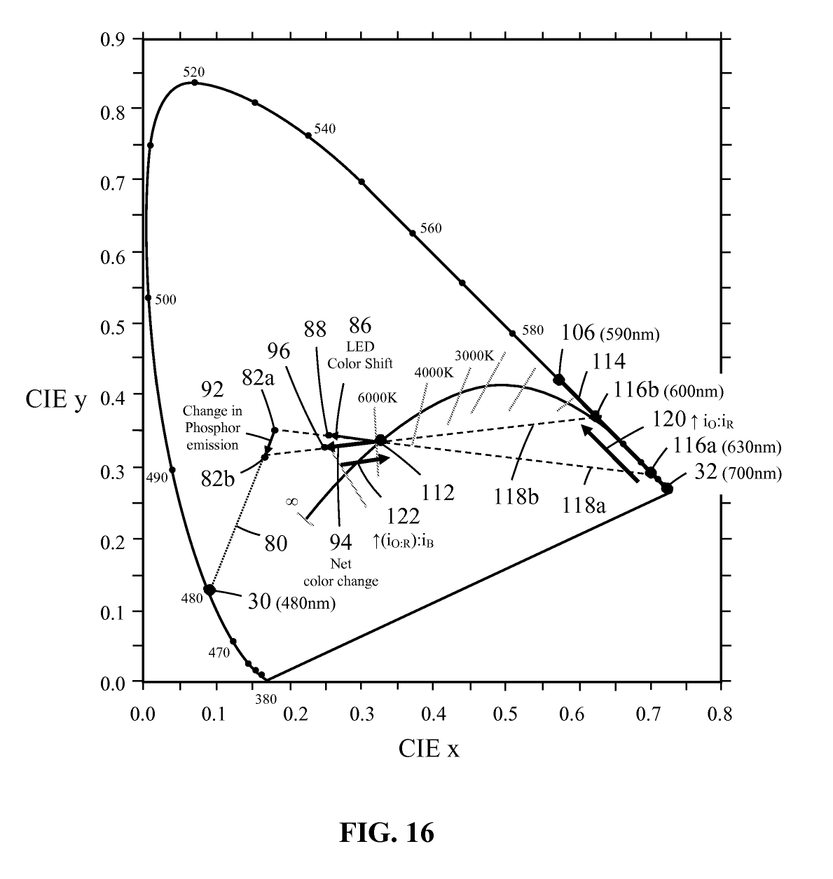

FIG. 16 is a C.I.E. 1931 Chromaticity Diagram indicating how the driver 48 can control the drive currents i_{B}, i_{R}, i_{O} of the blue, red and orange LEDs to compensate for changes in the relative emission characteristics of the LEDs due to ageing and/or operating temperature as well as changes in the emission characteristics of the phosphor material. In the system 110 is configured to generate white light 112 with a CCT of ≈5900K and is based on a blue LEDs that generates blue light 30 with an emission wavelength λ_{B}=480 nm, red LEDs that generates red light 32 with an emission wavelength λ_{R}=700 nm and orange LEDs that generate orange light 106 with an emission wavelength λ_{O}=590 nm. The ratio of the orange to red LED forward drive currents i_{O:R} is selected to ensure that the combined light 116a (630 nm) emitted by the orange and red LEDs results in the line 118a connecting the points 116a and 82a crosses the black body radiation curve 10 at a CCT≈5900K. The emission intensity of a red/orange LED typically drops more quickly than a blue LED with age and/or operating temperature. It will be assumed that fall in emission intensity of the orange and red LEDs is similar such that the ratio I_{O}:I_{R} remains approximately constant (i.e. point 116a remains fixed). As shown in FIG. 16 the effect of such a differential change in the emission characteristics of the LEDs causes a color shift 86 in the emission product 46 of the system away from the black body radiation curve 10 along the line 118a in a direction towards the point 82a. Without compensating for such a color shift 86 the system would no longer emit white light and would emit bluish green light as indicated by point 88. In accordance with the invention the effect of the color shift 86 can be reduced, or even eliminated, by changing the relative emissions of the blue and red/orange LEDs by controlling the drive currents i_{B}, i_{R}, i_{O}. Increasing (↑) the ratio (i_{O}:i_{R}):i_{B} (i.e. increasing the light output of the red and orange LEDs relative to that of the blue LED whilst maintaining the ratio i_{O}:i_{R} constant) the white light emitting system 110 can be configured to again emit white light 112 with a CCT of ≈2900K. It is contemplated that any change in the ratio I_{O}:I_{R} can be compensated for by changing the ratio i_{O}:i_{R}.

In addition to being able to compensate for changes in the emission characteristics of the blue, red and orange LEDs the system of the invention can also reduce the effect on the emission product of changes in the emission characteristics of the phosphor material. Typically changes in the emission characteristics of a phosphor material result in less photoluminescence light being generated and such changes can be considered to be equivalent to a reduction in phosphor material quantity. As indicated in FIG. 16 a change in the emission characteristics of the phosphor results in a change 92 in the combined light 82a emitted by the phosphor material and blue LED along the line 80 in a direction towards the point 30. The new color of the combined light emitted by the phosphor material and blue LED is indicated by point 82b. As indicated by arrow 94 the combined changes in phosphor emission and LED emission result in a net color change such that the system no longer emits white light as indicated by point 96.

In accordance with the invention the combined effect of these changes can be virtually eliminated by changing the ratio of light emitted by the orange and red LEDs and by changing the ratio of the orange/red to blue LED emission. By increasing (↑) the light output of the orange LED relative to the red LED (i.e. ↑i_{O}:i_{R}) the combined light generated by the orange and red LEDs (point 116b ≈600 nm) can be configured such that a line 118b connecting the points 82b and 116b will again cross the black body radiation curve 10 at a CCT of 2900K. By additionally increasing the ratio of orange/red LED output relative to that of the blue LED (i.e. ↑i_{O:R}:i_{B}) the system can be configured to again emit white light 112 with a CCT of 2900K. It is envisioned that by appropriate configuration of the system it should be possible to maintain the emission product of the system to within ±five, more preferably ±two, McAdams ellipses of a selected color and/or CCT.

It will be appreciated that LED-based light emitting systems and devices in accordance with the invention are not limited to exemplary embodiments described and that variations can be made within the scope of the invention. For example it will be appreciated that the blue and red LEDs can be packaged in other package arrangements. Preferably the packaging arrangement includes electrode pads 34, 36 that enable the drive current of the red and blue LEDs to be independently controllable and typically requires at least three electrode pads.

What is claimed is:

1. A light emitting device comprising:
a package;
at least one red LED housed in the package and operable to emit red light having a peak wavelength in a range 610 nm to 670 nm; and
at least one blue LED housed in the package and operable to emit blue light having a peak wavelength in a range 440 nm to 480 nm, wherein the emission product of the comprises the combination of light emitted by the red and blue LEDs and
characterized in that no blue light excitable phosphor is housed in the package.

2. The device of claim 1, wherein the package further comprises electrical contacts that are configured such that the drive current of the blue and red LEDs is independently controllable.

3. The device of claim 2, wherein the package comprises electrical contacts selected from the group consisting of: a respective electrical contact for the anode of the blue and red LEDs; a respective electrical contact for the cathode of the blue and red LEDs; a respective electrical contact for the anode and cathode of the blue and red LEDs; and a combination thereof.

4. A light emitting system comprising the device of claim 1 and further comprising at least one blue light excitable phosphor material that is operable to absorb at least a portion of the blue light emitted by the blue LED and in response emits light of a different color, wherein the emission product of the lighting system comprises a combination of light generated by the red and blue LEDs and light generated by the at least one phosphor material wherein the phosphor material is selected is operable to absorb at least a portion of the blue light emitted by the blue LED and in response emits light of a different color, wherein the emission product of the lighting system comprises a combination of light generated by the red and blue LEDs and light generated by the at least one phosphor material and wherein the least one phosphor material is provided remote to the device at a distance selected from the group consisting of: at least 5 mm, at least 10 mm and at least 20 mm.

5. The system of claim 4, and configured such that in operation the combination of light generated by the at least one blue LED and the at least one phosphor material has chromaticity values selected from the group consisting of: lying above the black body radiation curve of the C.I.E. 1931 chromaticity diagram; lying within an area of the C.I.E. 1931 chromaticity diagram bounded by straight line connecting points of C.I.E. values (0.08, 0.75), (0.43, 0.47), (0.22, 0.26) and (0.09, 0.23); and lying within an area of the C.I.E. 1931 chromaticity diagram bounded by straight line connecting points of C.I.E. values (0.15, 0.58), (0.42, 0.44), (0.29, 0.32), (0.09, 0.31) and (0.09, 0.45).

6. The system of claim 4, and configured such that the emission product appears white in color and has chromaticity values lying within two MacAdam ellipses of the black body radiation curve of the C.I.E. 1931 chromaticity diagram.

7. The system of claim 5 and further comprising a driver operable to control a drive current of the red and/or blue LEDs in response the measured emission intensities of the LEDs such as to maintain a substantially constant ratio of the blue to red light in the emission product.

8. The system of claim 5 and further comprising a driver operable to control a drive current of the red and/or blue LEDs such as to maintain a substantially constant ratio of the blue to red light in the emission product.

9. The light emitting system comprising the light emitting device of claim 1 and further comprising a driver operable to control a drive current of the red and/or blue LEDs such as to maintain the emission product of the system within five MacAdam ellipses of a selected color.

10. A light emitting device comprising:
a package;
at least one red LED housed in the package and operable to emit red light having a peak wavelength in a range 610 nm to 670 nm;
at least one blue LED housed in the package and operable to emit blue light having a peak wavelength in a range 440 nm to 480 nm; and
at least one orange LED housed in the package and operable to emit orange light having a peak wavelength in a range 590 nm to 630 nm, wherein the emission product of the comprises the combination of light emitted by the red and blue LEDs and wherein the package comprises electrical contacts that are configured such that the drive current of the blue, red and orange LEDs is independently controllable.

11. The device of claim 10, wherein the package comprises electrical contacts selected from the group consisting of: a respective electrical contact for the anode of the blue, red and orange LEDs; a respective electrical contact for the cathode of the blue, red and orange LEDs; a respective electrical contact for the anode and cathode of the blue, red and orange LEDs; and a combination thereof.

12. A light emitting device comprising:
a package;
at least one red LED housed in the package and operable to emit red light having a peak wavelength in a range 610 nm to 670 nm;
at least one blue LED housed in the package and operable to emit blue light having a peak wavelength in a range 440 nm to 480 nm, wherein the emission product of the device comprises the combination of light emitted by the red and blue LEDs; and
a light transmissive material in direct contact with and covering the LEDs and
wherein no blue light excitable phosphor is housed in the package.

13. The device of claim 12, wherein the package is selected from the group consisting of comprising: at least one recess for housing the blue and red LEDs, a respective recess for housing the blue and red LED; and an array of recesses in which each recess is configured to receive a respective blue or red LED.

14. The device of claim 12, wherein the package further comprises electrical contacts that are configured such that the drive current of the blue and red LEDs is independently controllable, the electrical contacts being selected from the group consisting of: a respective electrical contact for the anode of the blue and red LEDs; a respective electrical contact for the cathode of the blue and red LEDs; a respective electrical contact for the anode and cathode of the blue and red LEDs; and a combination thereof.

15. The device of claim 12, wherein the at least one blue LED is operable to generate blue light having C.I.E. chromaticity values within an area bounded by a straight line connecting points on the C.I.E. 1931 chromaticity diagram with C.I.E. values (0.08, 0.13) and (0.16, 0.01) and the boundary of the C.I.E. chromaticity diagram connecting said points.

16. The device of claim 12, wherein the at least one red LED is operable to generate red light having C.I.E. chromaticity values on a straight line connecting the points on the C.I.E. 1931 chromaticity diagram with C.I.E. values (0.66, 0.34) and (0.72, 0.28).

17. A light emitting system comprising the light emitting device of claim 12 and further comprising at least one blue light excitable phosphor material that is operable to absorb at least a portion of the blue light emitted by the blue LED and in response emits light of a different color and wherein the emission product of the system comprises a combination of light generated by the red and blue LEDs and light generated by the at least one phosphor material and wherein the phosphor material is selected from the group consisting of being provided remote to the device at a distance of: at least 5 mm, at least 10 mm and at least 20 mm.

18. The system of claim 17 and configured such that in operation the combination of light generated by the at least one blue LED and the at least one phosphor material has C.I.E. chromaticity values selected from the group consisting of: lying above the black body radiation curve of the C.I.E. 1931 chromaticity diagram; lying within an area of the C.I.E. 1931 chromaticity diagram bounded by straight line connecting points of C.I.E. values (0.08, 0.75), (0.43, 0.47), (0.22, 0.26) and (0.09, 0.23); and lying within an area of the C.I.E. 1931 chromaticity diagram bounded by straight line connecting points of C.I.E. values (0.15, 0.58), (0.42, 0.44), (0.29, 0.32), (0.09, 0.31) and (0.09, 0.45).

19. The system of claim 18, and configured such that in operation the emission product has chromaticity values lying within five MacAdam ellipses of the black body radiation curve of the C.I.E. 1931 chromaticity diagram.

20. The system of claim 17, and further comprising a driver operable to control a drive current of the red and/or blue LEDs in response the measured emission intensities of the LEDs such as to maintain a substantially constant ratio of the blue to red light in the emission product.
